(19) United States
(12) Patent Application Publication
(10) Pub. No.: US 2025/0131134 A1
(43) Pub. Date: Apr. 24, 2025

(54) METHOD, COMPUTER, AND COMPUTER-READABLE MEDIUM RELATED TO CERTIFICATION OF SIGNATORY OF DOCUMENT

(71) Applicant: Wacom Co., Ltd., Saitama (JP)

(72) Inventors: Joss Daniel GIFFARD-BURLEY, Frome (GB); Lars LENZ, Düsseldorf (DE); Peter SOMMER, Düsseldorf (DE); Avinav KHANAL, Düsseldorf (DE)

(21) Appl. No.: 19/001,163

(22) Filed: Dec. 24, 2024

Related U.S. Application Data
(63) Continuation of application No. PCT/JP2023/004107, filed on Feb. 8, 2023.

(30) Foreign Application Priority Data
Jul. 6, 2022 (JP) 2022-108998

(51) Int. Cl. G06F 21/64; G06F 21/60; H04L 9/06; H04L 9/08; H04L 9/32

(52) U.S. Cl. CPC G06F 21/64; G06F 21/602; H04L 9/0643; H04L 9/0822; H04L 9/3268

(57) ABSTRACT

Provided is a method executed by one or more computers, the method including acquiring a user decentralized identifier for identifying a signatory who provides a handwritten signature to an electronic document, calculating a hash value of a document file representing the electronic document provided with the handwritten signature by the signatory, and generating a certificate including the user decentralized identifier and the hash value of the document file.

### BACKGROUND

### Technical Field

The present disclosure relates to a method, a computer, and a computer-readable medium related to certification of a signatory of a document.

### Background Art

A technique for providing an electronic signature to an electronic document created with use of writing creation software or the like is known. The electronic signature is data obtained by encrypting a hash value of the document with a private key of an electronic signature issuer. A person who has received the document with an electronic signature can use a public key of the electronic signature issuer to decrypt the electronic signature and thereby acquire the hash value of the document. The person can further derive a hash value of the received document and compare the hash values to recognize whether or not the document is tampered.

In addition, a technique for using feature matching of handwriting data to perform user authentication is known in recent years. An example of this type of technique is disclosed in Patent Document 1.

### PRIOR ART DOCUMENT

### Patent Document

Patent Document 1: Japanese Patent No. 6480710

### BRIEF SUMMARY

### Technical Problem

However, who the signatory of the document (person responsible for creating the document) is cannot be certified in a conventional electronic signature.

Therefore, an object of the present disclosure is to provide a method, a computer, and a computer-readable medium related to certification of a signatory of a document.

### Technical Solution

The present disclosure provides a method performed by one or more computers, the method including acquiring a user decentralized identifier for identifying a signatory who provides a handwritten signature to an electronic document, calculating a hash value of a document file representing the electronic document provided with the handwritten signature by the signatory, and generating a certificate including the user decentralized identifier and the hash value of the document file.

The present disclosure provides a computer including a processor, in which the processor is configured to acquire a user decentralized identifier for identifying a signatory who provides a handwritten signature to an electronic document, calculate a hash value of a document file representing the electronic document provided with the handwritten signature by the signatory, and generate a certificate including the user decentralized identifier and the hash value of the document file.

The present disclosure provides a program for causing a computer to execute a process of acquiring a user decentralized identifier for identifying a signatory who provides a handwritten signature to an electronic document, calculating a hash value of a document file representing the electronic document provided with the handwritten signature by the signatory, and generating a certificate including the user decentralized identifier and the hash value of the document file.

### Advantageous Effect

According to the method, the computer, and the computer-readable medium of the present disclosure, certification of a signatory of a document can be realized.

### BRIEF DESCRIPTION OF THE SEVERAL VIEWS OF THE DRAWINGS

FIG. 1 is a diagram illustrating a configuration of a certificate issuance system 1 according to the present disclosure.

FIG. 2 is a diagram illustrating an example of a hardware configuration of a user terminal 3, an application server 4, and a signature authentication server 5.

FIG. 3 is a diagram illustrating a configuration of biometric signature data.

FIG. 4A is a diagram illustrating a configuration of a user DID document, and FIG. 4B is a diagram illustrating a configuration of a document DID document.

FIG. 5A is a diagram illustrating a configuration of a signed VC for a user, and FIG. 5B is a diagram illustrating a configuration of a signed VC for a document.

FIGS. 6A to 6D are diagrams illustrating an overview of a signed VC issuance process.

FIG. 7 is a diagram illustrating a process flow of the signed VC issuance process.

FIG. 8 is a process flow chart illustrating details of a signature authentication process executed in step S7 of FIG. 7.

FIG. 9 is a process flow chart illustrating the details of the signature authentication process executed in step S7 of FIG. 7.

FIG. 10 is a process flow chart illustrating the details of the signature authentication process executed in step S7 of FIG. 7.

FIG. 11 is a process flow chart illustrating details of a signature process executed in step S11 of FIG. 7.

FIG. 12 is a process flow chart illustrating the details of the signature process executed in step S11 of FIG. 7.

FIG. 13 is a process flow chart illustrating details of a signed VC generation process executed in step S12 of FIG. 7.

FIG. 14 is a diagram illustrating a process flow of a signatory certification process.

FIG. 15 is a diagram illustrating the process flow of the signatory certification process.

FIG. 16 is a diagram illustrating the process flow of the signatory certification process.

### DETAILED DESCRIPTION OF THE PREFERRED EMBODIMENTS

Hereinafter, an embodiment of the present disclosure will be described in detail with reference to the attached drawings.

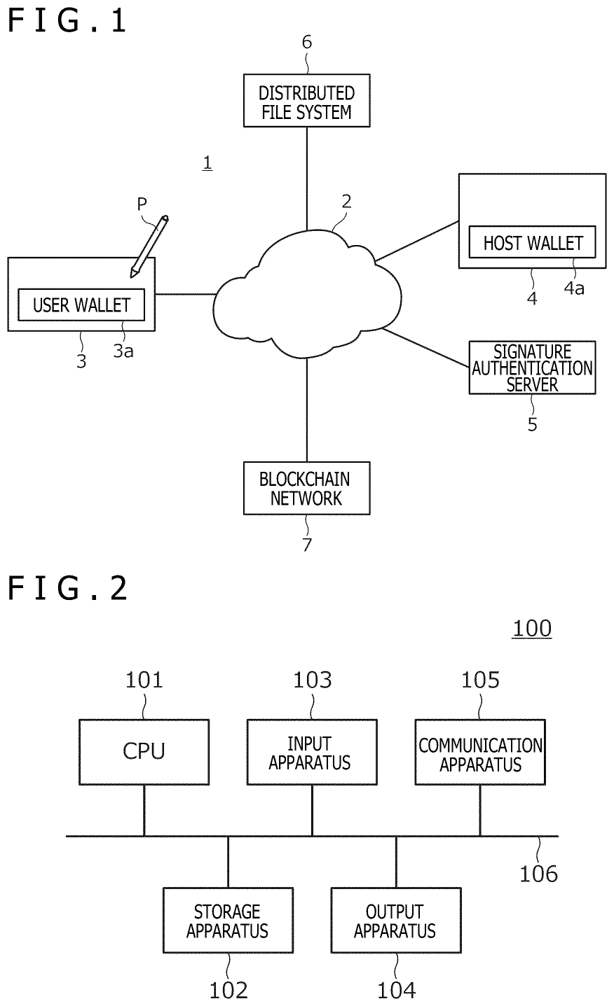

FIG. 1 is a diagram illustrating a configuration of a certificate issuance system 1 according to the present embodiment. As illustrated in FIG. 1, the certificate issuance system 1 includes a user terminal 3, an application server 4, a signature authentication server 5, a distributed file system 6, and a blockchain network 7 connected to each other through a network 2.

FIG. 2 is a diagram illustrating an example of a hardware configuration of the user terminal 3, the application server 4, and the signature authentication server 5. The user terminal 3, the application server 4, and the signature authentication server 5 may each include a computer 100 having the illustrated configuration. Note that the application server 4 and the signature authentication server 5 may each be provided by coupling a plurality of computers 100. In addition, some or all of the functions of each of the application server 4 and the signature authentication server 5 may be implemented as applications in the computer 100 included in the user terminal 3.

As illustrated in FIG. 2, the computer 100 includes a CPU (Central Processing Unit) 101, a storage apparatus 102, an input apparatus 103, an output apparatus 104, and a communication apparatus 105 connected to each other through a bus 106.

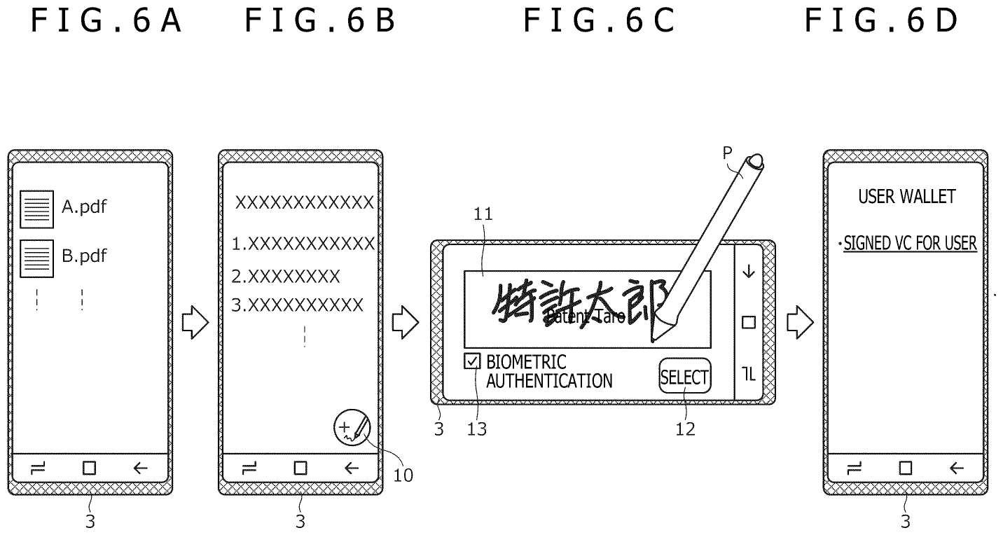

The CPU 101 is an apparatus configured to control the components of the computer 100 and read and execute various kinds of programs stored in the storage apparatus 102. The CPUs 101 of the user terminal 3, the application server 4, and the signature authentication server 5 execute the programs stored in the respective storage apparatuses 102, to realize processes described later with reference to FIGS. 6A to 16.

The storage apparatus 102 includes a main storage apparatus, such as a DRAM (Dynamic Random Access Memory), and an auxiliary storage apparatus, such as a hard disk, and plays a role of storing various kinds of programs for executing an operating system of the computer 100 and various kinds of applications and a role of storing data used by the programs.

The input apparatus 103 is an apparatus that receives an input operation of a user and supplies the input operation to the CPU 101, and the input apparatus 103 includes, for example, a keyboard, a mouse, and a touch detection apparatus. Of these, the touch detection apparatus is an apparatus including a touch sensor and a touch controller, and the touch detection apparatus is used to detect pen input or touch input. A pen P illustrated in FIG. 1 is an electronic pen used for performing pen input to the touch detection apparatus of the user terminal 3. The pen input by the pen P is realized by, for example, an active capacitance system or an electromagnetic resonance system.

The output apparatus 104 is an apparatus that outputs a processing result of the CPU 101 to the user, and the output apparatus 104 includes, for example, a display and a speaker. The communication apparatus 105 is an apparatus for communicating with an external apparatus, and the communication apparatus 105 transmits and receives data according to an instruction of the CPU 101. The user terminal 3, the application server 4, and the signature authentication server 5 each use the communication apparatus 105 to communicate with other apparatuses, systems, networks, and the like including the illustrated blockchain network 7 and distributed file system 6.

FIG. 1 will further be described. The user terminal 3 is a terminal in which a signatory of a document to be signed is the user, and the user terminal 3 includes, for example, a personal terminal, such as a smartphone, a tablet terminal, and a personal computer. Examples of the document to be signed include various kinds of contracts, exhibition application forms of artworks, and the like. When the signatory uses the pen P to enter the signature in a signature field of the document displayed on a display of the user terminal 3, the user terminal 3 executes a process of generating biometric signature data representing the handwritten signature.

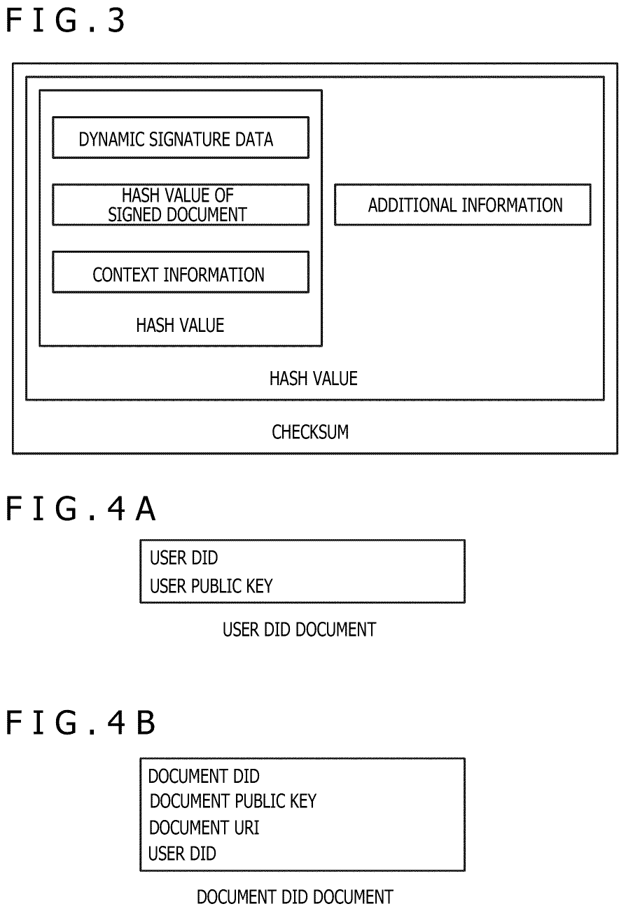

FIG. 3 is a diagram illustrating a configuration of the biometric signature data. The biometric signature data is data generated according to, for example, an FSS (Forensic Signature Stream) or WILL (Wacom Ink Layer Language). As illustrated in FIG. 3, the biometric signature data includes dynamic signature data, a hash value of a signed document, context information, additional information, a hash value of the dynamic signature data, the hash value of signed document, and a hash value of the context information, a hash value of the hash value and the additional information, and a checksum for detecting an error that may occur when the hash value is transmitted or received. Hereinafter, an example of using the biometric signature data generated according to an FSS will be described, and the biometric signature data will simply be referred to as an “FSS.” However, it is obvious that the biometric signature data generated according to WILL may also be used.

The dynamic signature data is digital ink data including a series of pieces of coordinate data included in a line drawing. Each piece of coordinate data is data representing the position of the pen P detected by the touch detection apparatus. The detection will be described in detail. The touch sensor includes a plurality of X electrodes that extend in a Y direction and are arranged at equal intervals in an X direction and a plurality of Y electrodes that extend in the X direction and are arranged at equal intervals in the Y direction. If the pen P is configured to be capable of transmitting a signal, each of the plurality of X electrodes and the plurality of Y electrodes receives a burst signal transmitted by the pen P, and the touch controller acquires the coordinate data representing the position of the pen P. Meanwhile, if the pen P is not capable of transmitting a signal, the touch controller sequentially transmits a signal to each of the plurality of X electrodes, and each of the plurality of Y electrodes receives the signal. The touch controller detects a change in amplitude of the received signal to acquire the coordinate data representing the position of the pen P. The touch controller is configured to collect the coordinate data at a frequency of, for example, 100 times or 200 times per second.

The hash value of signed document is a value obtained by inputting electronic data of signed document (hereinafter, referred to as a “document file”) into a predetermined one-way hash function. The same is true for the other hash values, and the hash value is a value obtained by inputting target electronic data into a predetermined one-way hash function.

The context information is information including name data of a signatory, date of signing, purpose of signing, information regarding the touch detection apparatus used for signing (such as a manufacturer name and a model name), information regarding an application used for signing (such as an application name and version information), information regarding an operating system of the user terminal 3 (such as operating system name and version information), address information regarding the user terminal 3 (such as an IP address and a MAC address), and the like. The additional information is information that an administrator of the certificate issuance system 1 can designate as desired, in addition to the dynamic signature data, the hash value of signed document, and the context information.

FIG. 1 will further be described. The user terminal 3 includes a user wallet 3a that is an application for managing decentralized identity (Decentralized Identifier, hereinafter referred to as a “DID”). The DID is a decentralized ID used in self-sovereign identity (which is a mechanism in which the user can possess and control the identity (hereinafter, referred to as “ID”) of the user without the involvement of a management entity to thereby solve the problems of centralized ID management and is hereinafter referred to as “SSI”), and the DID is permanently recorded in the blockchain network 7.

The user wallet 3a does not store the DID per se, but stores a token ID issued from the blockchain network 7 when the DID is recorded, to thereby manage the DID. When the user terminal 3 needs to acquire the DID, the user terminal 3 accesses the blockchain network 7 on the basis of the token ID of the DID to be acquired, to thereby acquire the DID. The DID managed by the user wallet 3a includes a DID (hereinafter, referred to as a “user DID”) for identifying the user of the user terminal 3.

In addition, for each DID, the user wallet 3a can store a key pair (pair of a private key and a public key) based on public key cryptography and an encryption key based on common key cryptography. Hereinafter, the private key, the public key, and the encryption key corresponding to the user DID will be referred to as a “user private key,” a “user public key,” and a “user encryption key,” respectively. The keys are generated by the user terminal 3 when the user DID is newly issued, and the keys are stored in the user wallet 3a.

The DID includes information representing the location of information (hereinafter, referred to as a “DID document”) specifically representing the details of the ID. The DID document is usually stored in the distributed file system 6, and in this case, the information representing the location of the DID document is a hash value of the DID document. The DID document corresponding to the user DID will be referred to as a “user DID document.”

FIG. 4A is a diagram illustrating a configuration of the user DID document. As illustrated in FIG. 4A, the user DID document includes the user DID and the user public key. Since the DID document is information that can be accessed by anyone by using the corresponding DID as a search key, the user public key is released widely in the world when the user public key is arranged in the user DID document.

FIG. 1 will further be described. The user terminal 3 executes a process of receiving, from the application server 4, the document file that represents the document to be signed and presenting the document file to the signatory. In addition, the user terminal 3 also executes a process of generating verifiable certificates (verifiable credentials) that are certificates used in the SSI, when the signatory enters the signature in the signature field in the presented document file. The verifiable certificates (hereinafter, referred to as “signed VCs”) generated by the user terminal 3 include hash values of the user DID and the document file. In addition, the signed VCs generated by the user terminal 3 are subsequently provided with an electronic signature by the application server 4. Note that the electronic signature is generated by deriving, that is, calculating, a hash value of target electronic data (signed VC in this case) and using a predetermined encryption key (in this case, a host private key described later) to encrypt the hash value. The same is true for other electronic signatures described later.

The signed VCs generated by the user terminal 3 include a signed VC for a user used for the management by the user and a signed VC for document used for the management by the administrator of the certificate issuance system 1. The signed VC for the user is managed by the user wallet 3a, and the signed VC for document is managed by a host wallet 4a in the application server 4 described later.

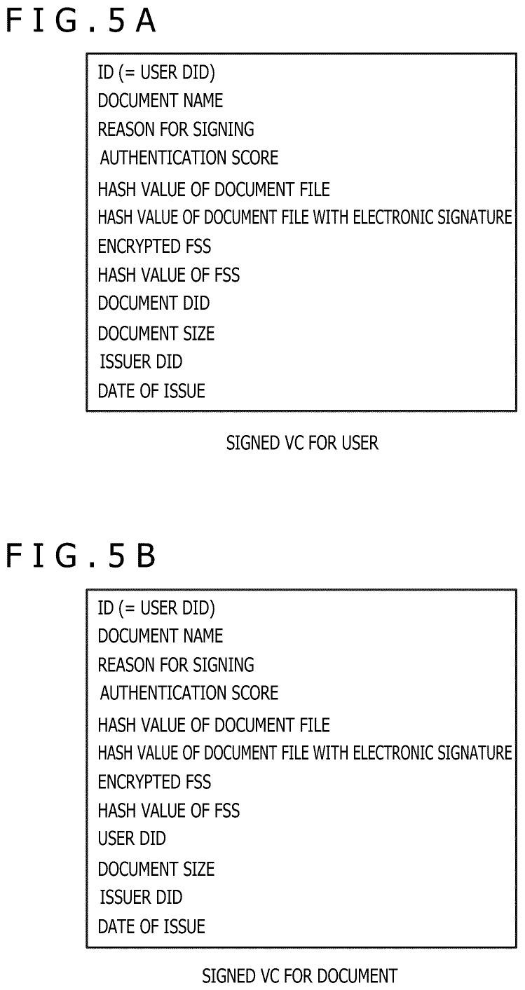

FIG. 5A is a diagram illustrating a configuration of the signed VC for user, and FIG. 5B is a diagram illustrating a configuration of the signed VC for document. As can be understood from FIGS. 5A and 5B, the signed VC for user and the signed VC for document are information including the same contents, except that pieces of ID as main keys are different. Specifically, the signed VC for user includes a signatory DID as a main key and includes information regarding a document name, a reason for signing, an authentication score, a hash value of a document file, a hash value of a document file with an electronic signature, an encrypted FSS, a hash value of an FSS, a document DID, a document size, an issuer DID, and the date of issue. In addition, the signed VC for document includes a document DID as a main key and includes information regarding a document name, a reason for signing, an authentication score, a hash value of a document file, a hash value of a document file with an electronic signature, an encrypted FSS, a hash value of an FSS, a signatory DID, a document size, an issuer DID, and the date of issue.

FIG. 1 will further be described. The application server 4 is a server computer configured to manage a document that has not yet been signed and a document that has been signed and execute various kinds of processes related to the signing of the document. Although the entity of the document file representing the document is stored in the distributed file system 6, the application server 4 also stores a replica of the document to prevent the loss of document. An example of the application server 4 includes a server computer as part of a banking system or an artwork trade system.

The application server 4 includes the host wallet 4a that is an application for managing a DID, a private key, a public key, and an encryption key, as with the user wallet 3a. The DID managed by the host wallet 4a includes a DID (hereinafter, referred to as a “host DID”) for identifying the administrator (host) of the certificate issuance system 1. Hereinafter, the private key and the public key corresponding to the host DID will be referred to as a “host private key” and a “host public key,” respectively. The keys are generated by the application server 4 when the host DID is newly issued, and the keys are stored in the host wallet 4a.

The application server 4 executes a process of providing a document file representing the document to be signed to the user terminal 3 in response to a request from the user terminal 3 and also executes a process of issuing a DID (hereinafter, referred to as a “document DID”) that identifies the provided document and recording the document DID in the blockchain network 7. When issuing the document DID, the application server 4 also executes a process of newly generating a DID document, a private key, and a public key of the document DID (hereinafter, referred to as a “document DID document,” a “document private key,” and a “document public key,” respectively).

FIG. 4B is a diagram illustrating a configuration of the document DID document. As illustrated in FIG. 4B, the document DID document includes a document DID, a document public key, a document URI (Uniform Resource Identifier), and a user DID. The document URI is an address of the document in the distributed file system 6. The user DID is a DID of the user of the user terminal 3 who has requested to issue the document DID.

FIG. 1 will further be described. The signature authentication server 5 is a server computer that authenticates the handwritten signature. Specifically, the signature authentication server 5 executes a process of receiving, from the user terminal 3, a signature template generated on the basis of one or more past signatures of the user and an FSS representing the handwritten signature to be authenticated and calculating a degree of similarity (hereinafter, referred to as a “authentication score”) between the handwritten signature indicated by the FSS and one or more signatures included in the signature template. The signature authentication server 5 is configured to return the authentication score as a result of the authentication process.

The distributed file system 6 is a network of a plurality of computers connected peer-to-peer, and the distributed file system 6 is, for example, an interplanetary file system. The distributed file system 6 can store any electronic data, and the electronic data stored in the distributed file system 6 is identified by a hash value of the electronic data. That is, the hash value of the stored electronic data functions as a URI of the electronic data in the distributed file system 6. In the present embodiment, the distributed file system 6 is used to store the document file and the DID document.

The blockchain network 7 is a network of a plurality of computers connected peer-to-peer, and the blockchain network 7 is, for example, an Ethereum network. The blockchain network 7 includes a blockchain that can record various transactions including an issue transaction of a DID. Some computers (hereinafter, referred to as “miners”) connected to the blockchain network 7 record the transactions in the blockchain.

Specifically, each block included in the blockchain includes a block header and data (trade data) representing specific details of the transaction. Of these, the block header includes a Merkle route that is data obtained by compressing the size of the trade data, a hash value of the previous block, and a nonce value that is any character string. A rule that the hash value of a new block needs to satisfy a predetermined condition (for example, a condition that the value starts with “000”) in order to connect the block to the blockchain is set in the blockchain network 7. Therefore, the miners trying to record a block in the blockchain perform an operation of finding (mining) the nonce value in a round-robin manner in order for the hash value of the block header of the block to satisfy the predetermined condition. As a result of the operation, the miner that has first succeeded in discovering the nonce value connects the block to the blockchain to complete the recording of the transaction in the blockchain.

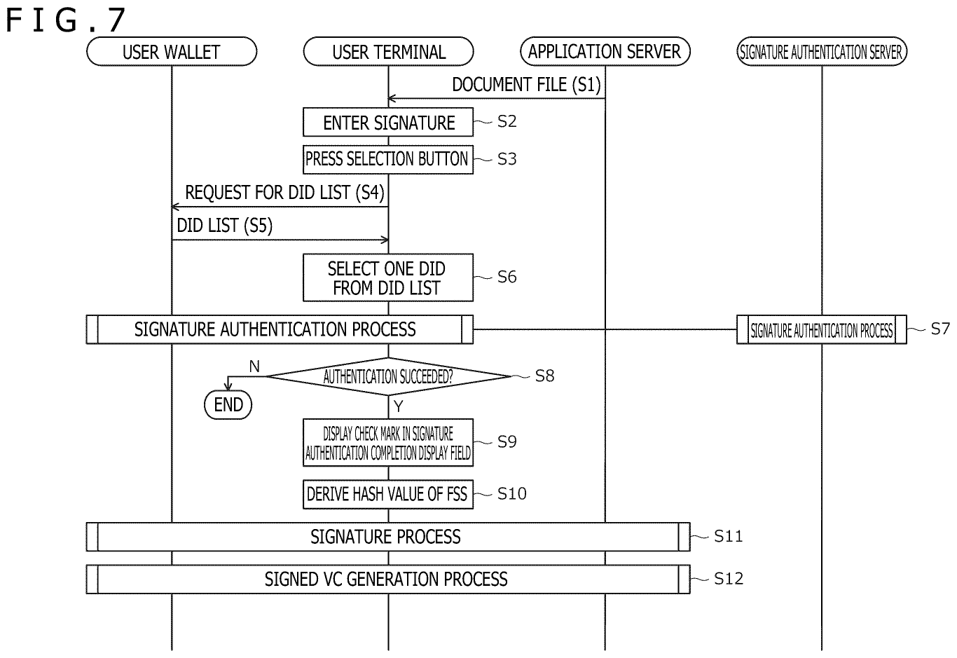

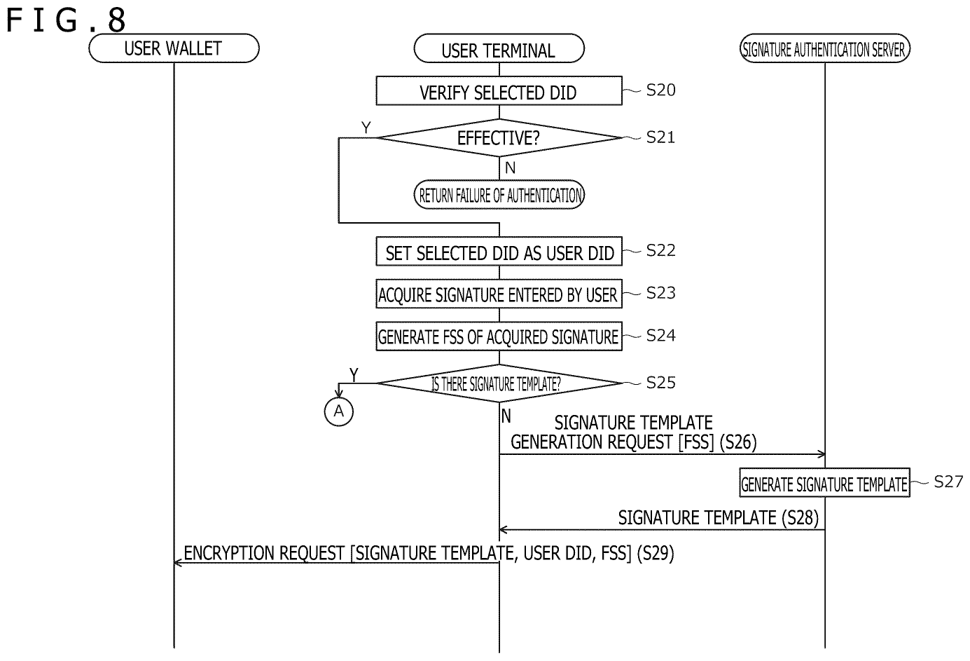

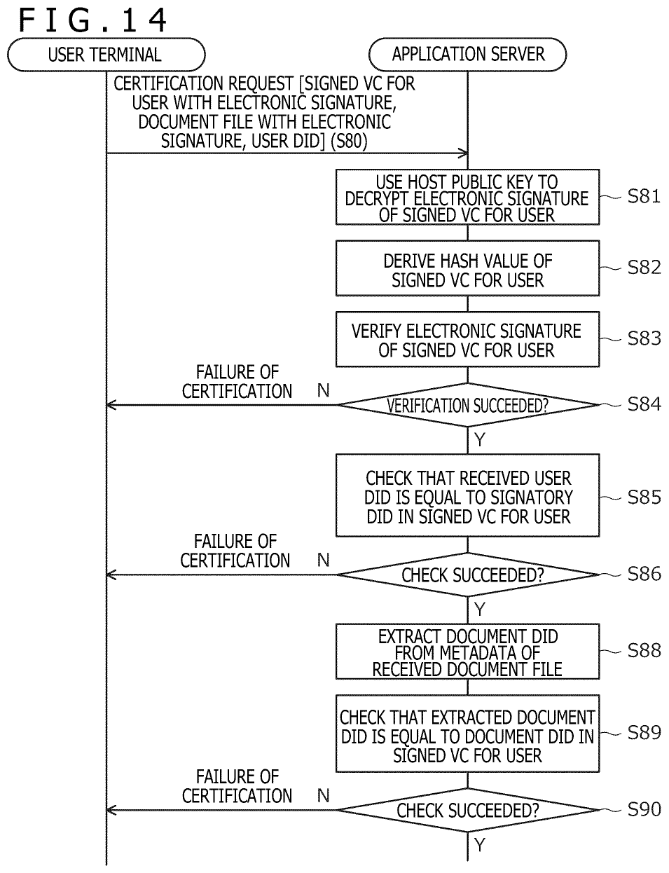

Hereinafter, processes executed by the user terminal 3, the application server 4, and the signature authentication server 5 in relation to the signed VCs will specifically be described. An overview of a process for issuing the signed VCs (hereinafter, referred to as a “signed VC issuance process”) will be described first with reference to FIG. 6A to 6D, and then, the details of the signed VC issuance process will be more specifically described with reference to FIGS. 7 to 13. Subsequently, a process of certifying the signatory by using the issued signed VCs (hereinafter, referred to as a “signatory certification process”) will be described with reference to FIGS. 14 to 16.

FIGS. 6A to 6D are diagrams illustrating the overview of the signed VC issuance process. First, in FIG. 6A, the user terminal 3 displays, in a selectable manner, one or more document files stored in the application server 4 to the user. Although the specific type of the document files is typically a PDF (Portable Document Format) file as illustrated in FIG. 6A, other types of files may be provided.

When the user selects one of the one or more displayed document files by a tap operation or the like, the user terminal 3 opens the selected document file as illustrated in FIG. 6B, to allow the user to check the details. In addition, the user terminal 3 displays a signature start button 10 in the screen.

When the user who has checked the details of the displayed document file and determined to sign the document file presses the signature start button 10, the user terminal 3 displays a signature screen illustrated in FIG. 6C. The signature screen includes a signature field 11, a selection button 12, and a signature authentication completion display field 13. When the user uses the pen P to enter the signature in the signature field 11 and presses the selection button 12, the user terminal 3 starts a process for issuing the signed VCs. The details of the process will be described later with reference to FIGS. 7 to 13, and the process includes authentication of the signature by the signature authentication server 5. The user terminal 3 is configured to determine whether or not the authentication has succeeded, on the basis of an authentication score received as a result of the authentication from the signature authentication server 5, and display a check mark indicating the success of authentication in the signature authentication completion display field 13 if the user terminal 3 determines that the authentication has succeeded.

When the issuance of the signed VCs including the signed VC for user and the signed VC for document is completed, the signed VC for user is stored in the user wallet 3a as illustrated in FIG. 6D. The user of the user terminal 3 can later submit the signed VC for user to the application server 4 along with the user DID and the document file with an electronic signature (or the electronic signature of the document file) to thereby prove that the user is the signatory of the document file.

FIGS. 7 to 13 are diagrams illustrating a process flow of the signed VC issuance process. Although the user terminal 3 and the user wallet 3a are separately displayed in FIGS. 7 to 13, they are separately displayed just for convenience, and the actual user wallet 3a is installed in the user terminal 3 in the present embodiment as described above.

First, the application server 4 supplies the document file to the user terminal 3 (step S1). When the user of the user terminal 3 signs in the signature field 11 (see FIG. 6C) of the document file (step S2) and presses the selection button 12 (see FIG. 6C) (step S3), the user terminal 3 requests the user wallet 3a for a DID list (step S4). The user wallet 3a generates a list of managed DIDs according to the request and returns the list to the user terminal 3 (step S5). The user terminal 3 allows the user to select one DID from the DID list acquired in this way (step S6) and starts a signature authentication process for authenticating the signature (step S7).

FIGS. 8 to 10 are a process flow chart illustrating the details of the signature authentication process executed in step S7. The user terminal 3 first verifies whether or not the DID selected in step S6 is an effective DID (step S20). Specifically, the user terminal 3 can refer to the blockchain network 7 to check whether or not the selected DID actually exists and determine that the DID is an effective DID, if the user terminal 3 can confirm that the DID exists. The user terminal 3 determines whether or not the DID is an effective DID, as a result of the verification (step S21). If the user terminal 3 determines that the DID is not effective, the user terminal 3 returns information indicating the failure of authentication. Meanwhile, if the user terminal 3 determines that the DID is effective, the user terminal 3 sets the selected DID as the user DID (step S22).

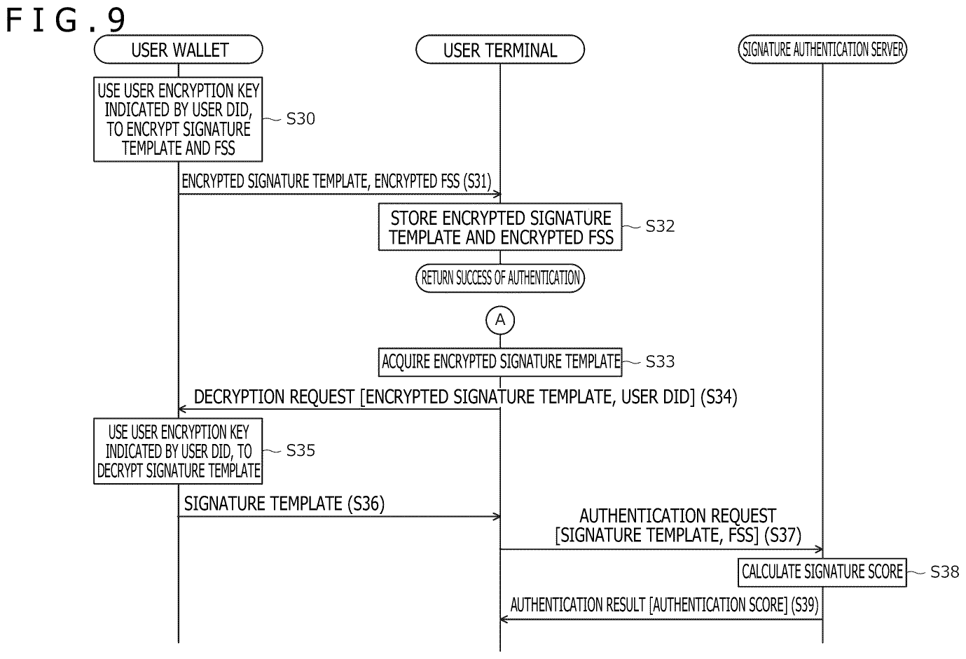

Next, the user terminal 3 acquires the signature entered by the user in the signature field 11 (step S23) and generates an FSS of the acquired signature (step S24). Subsequently, the user terminal 3 determines whether or not the signature template of the user is stored (step S25). If the user terminal 3 determines that the signature template of the user is stored, the user terminal 3 advances the process to step S33 of FIG. 9. Meanwhile, if the user terminal 3 determines that the signature template of the user is not stored, the user terminal 3 generates a generation request of the signature template including the FSS generated in step S24 and transmits the generation request to the signature authentication server 5 (step S26).

The signature authentication server 5 that has received the generation request of the signature template generates the signature template on the basis of the received FSS (step S27) and returns the signature template to the user terminal 3 (step S28). The user terminal 3 that has received the signature template generates an encryption request including the signature template received from the signature authentication server 5, the user DID set in step S22, and the FSS generated in step S24 and transmits the encryption request to the user wallet 3a (step S29).

Described now with reference to FIG. 9, the user wallet 3a that has received the encryption request uses the user encryption key indicated by the user DID, to encrypt the signature template and the FSS (step S30), and returns the encrypted signature template and the encrypted FSS obtained as a result of the encryption to the user terminal 3 (step S31). The user terminal 3 stores, in the storage apparatus 102 of the user terminal 3 (see FIG. 2), the encrypted signature template and the encrypted FSS received from the user wallet 3a (step S32) and returns information indicating the success of authentication. As can be understood from the process of steps S26 to S32, the substantial authentication process is not executed if the user terminal 3 does not store the signature template of the user.

In step S33, the user terminal 3 acquires the stored signature template (step S33). The signature template acquired in this way is encrypted by the user encryption key. Therefore, the user terminal 3 generates a decryption request including the acquired encrypted signature template and the user DID set in step S22 and transmits the decryption request to the user wallet 3a (step S34). The user wallet 3a uses the user encryption key indicated by the user DID, to decrypt the encrypted signature template, and returns the signature template obtained as a result of the decryption to the user terminal 3 (step S36).

The user terminal 3 that has received the decrypted signature template generates an authentication request including the received signature template and the FSS generated in step S24 and transmits the authentication request to the signature authentication server 5 (step S37). The signature authentication server 5 that has received the authentication request uses the received signature template and FSS to calculate the authentication score and returns an authentication result including the calculated authentication score to the user terminal 3 (step S39).

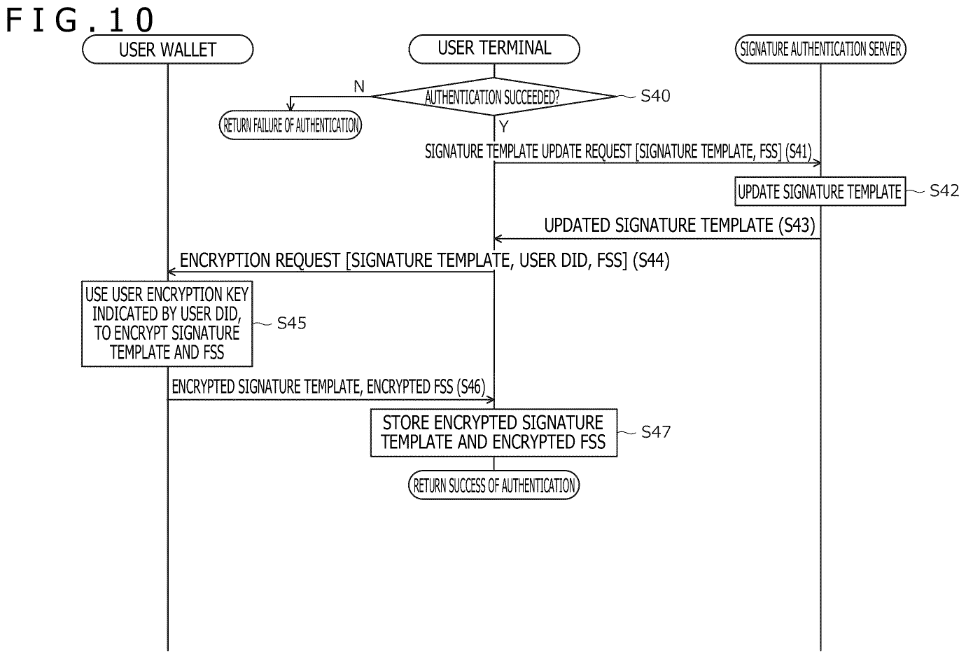

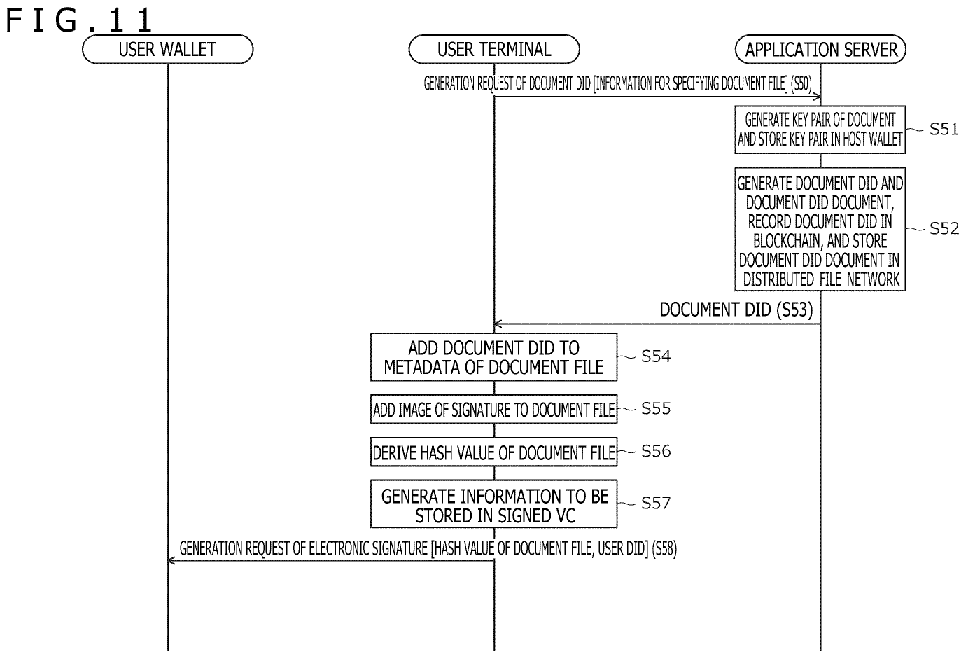

Described now with reference to FIG. 10, the user terminal 3 that has received the authentication result determines whether or not the signature authentication has succeeded, on the basis of the received authentication result (step S40). Specifically, the user terminal 3 can determine that the authentication has succeeded, if the authentication score is equal to or greater than a predetermined value, and determine that the authentication has failed, in other cases. The user terminal 3 that has determined in step S40 that the authentication has failed returns information indicating the failure of authentication.

Meanwhile, the user terminal 3 that has determined in step S40 that the authentication has succeeded generates an update request of the signature template including the signature template received in step S36 and the FSS generated in step S24 and transmits the update request to the signature authentication server 5 (step S41). The signature authentication server 5 that has received the update request of the signature template updates the received signature template by adding the signature indicated by the received FSS (step S42) and returns the updated signature template to the user terminal 3 (step S43).

Next, the user terminal 3 generates an encryption request including the updated signature template, the user DID set in step S22, and the FSS generated in step S24 and transmits the encryption request to the user wallet 3a (step S44). The user wallet 3a that has received the encryption request uses the user encryption key indicated by the user DID, to encrypt the signature template and the FSS (step S45), and returns the encrypted signature template and the encrypted FSS obtained as a result of the encryption to the user terminal 3 (step S46). The user terminal 3 stores, in the storage apparatus 102 of the user terminal 3 (see FIG. 2), the encrypted signature template and the encrypted FSS received from the user wallet 3a (step S47) and returns information indicating the success of authentication.

FIG. 7 will further be described. When the signature authentication process is finished, the user terminal 3 determines whether or not the authentication has succeeded, on the basis of the return result of the signature authentication process (step S8). As a result, the user terminal 3 ends the signed VC issuance process if the user terminal 3 determines that the authentication has failed. In this case, the signed VC is not issued. Meanwhile, the user terminal 3 that has determined that the authentication has succeeded displays a check mark in the signature authentication completion display field 13 illustrated in FIG. 6C (step S9) and further derives a hash value of the FSS generated in step S24 of FIG. 8 (step S10). Subsequently, the user terminal 3 executes a signature process for generating a signed document (step S11).

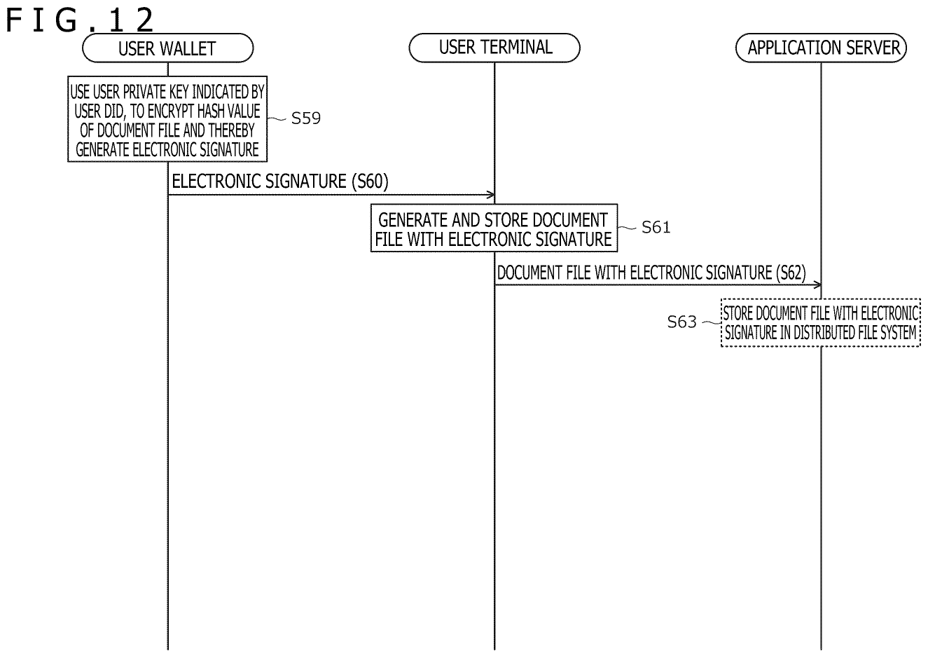

FIGS. 11 and 12 are a process flow chart illustrating the details of the signature process executed in step S11. The user terminal 3 first generates a generation request of the document DID including the information for specifying the document file and transmits the generation request to the application server 4 (step S50). The application server 4 that has received the generation request generates a document private key and a document public key and stores the keys in the host wallet 4a (step S51). Next, the application server 4 generates a document DID and a document DID document. The application server 4 records the document DID in the blockchain network 7 and stores the document DID document in the distributed file system 6 (step S52). Subsequently, the application server 4 returns the generated document DID to the user terminal 3 (step S53).

The user terminal 3 executes a process of adding the document DID received from the application server 4 to metadata of the document file (step S54). The process may be a process of adding the document DID to a DocMDP (Document Modification Detection and Prevention) field when, for example, the document file is a PDF file. In addition, the user terminal 3 also executes a process of adding, to the document file, an image (image obtained by rasterizing dynamic signature data) or dynamic signature data of the signature acquired in step S23 of FIG. 8 (step S55).

Next, the user terminal 3 derives a hash value of the document file (step S56) and further generates information to be stored in the signed VC (step S57). The information generated in step S57 is information including the signatory DID (user DID set in step S22 of FIG. 8), the document name, the reason for signing, the authentication score (received in step S39 of FIG. 9), the hash value of the document file (derived in step S57), the encrypted FSS (stored in step S32 of FIG. 9 or step S47 of FIG. 10), the hash value of the FSS (derived in step S10 of FIG. 7), the document DID (received in step S53), and the document size among the pieces of information illustrated in FIGS. 5A and 5B. Note that the document name and the document size can be acquired from the property of the document file. In addition, the reason for signing can be acquired by allowing the user to input or select the reason.

Next, the user terminal 3 generates a generation request of an electronic signature including the hash value generated in step S56 and the user DID set in step S22 of FIG. 8 and transmits the generation request to the user wallet 3a (step S58).

Described now with reference to FIG. 12, the user wallet 3a that has received the generation request of the electronic signature uses the user private key indicated by the user DID, to encrypt the hash value of the document file and thereby generate an electronic signature of the document (step S59). The user wallet 3a then returns the generated electronic signature to the user terminal 3 (step S60). The user terminal 3 that has received the electronic signature uses the received electronic signature to generate a document file with the electronic signature and stores the document file with the electronic signature in the storage apparatus 102 of the user terminal 3 (see FIG. 2) (step S61). The user terminal 3 also transmits the document file with the electronic signature to the application server 4 (step S62) and ends the signature process. Subsequently, the application server 4 may store the received document file with the electronic signature in the distributed file system 6 (step S63).

FIG. 7 will further be described. When the signature process is finished, the user terminal 3 then executes a signed VC generation process for generating the signed VCs (step S12).

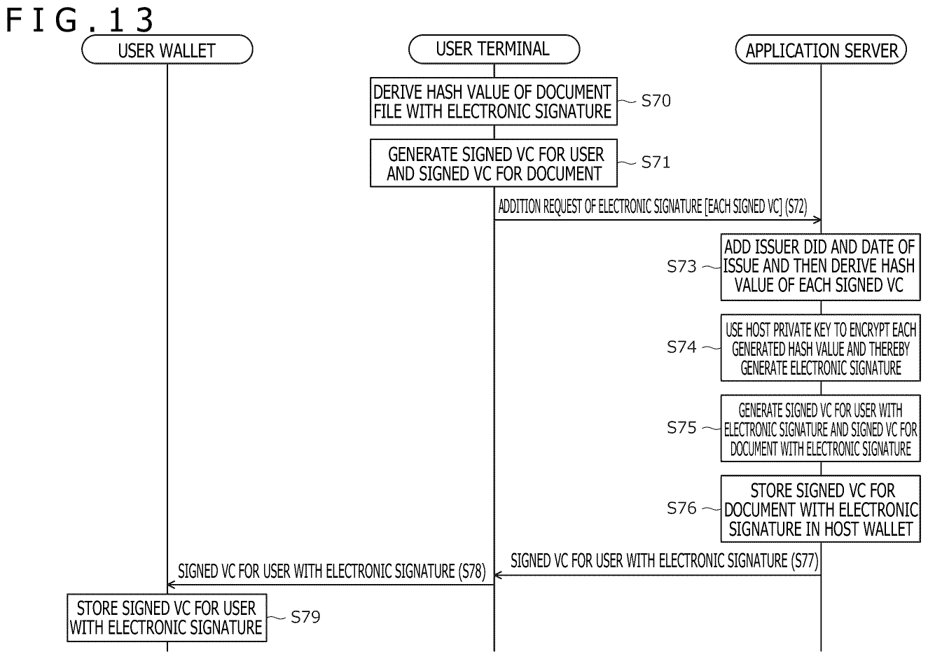

FIG. 13 is a process flow chart illustrating the details of the signed VC generation process executed in step S12. The user terminal 3 in the process first derives a hash value of the document file with the electronic signature stored in step S61 of FIG. 12 (step S70). The user terminal 3 then uses the derived hash value and the information generated in step S56 of FIG. 11, to generate a signed VC for user and a signed VC for document (step S71). Next, the user terminal 3 generates an addition request of the electronic signature including the generated signed VCs and transmits the addition request to the application server 4 (step S72).

The application server 4 that has received the addition request of the electronic signature adds the host DID and current date as the issuer DID and the date of issue, respectively, to the signed VCs and then derives hash values of the signed VCs (step S73). The application server 4 uses the host private key to encrypt the derived hash values and thereby generate electronic signatures of the signed VCs (step S74). The application server 4 then adds the generated electronic signatures to the signed VCs to thereby generate a signed VC for user with the electronic signature and a signed VC for document with the electronic signature (step S75).

The application server 4 stores, in the host wallet 4a, the signed VC for document with the electronic signature of the two signed VCs with the electronic signatures generated in step S75 (step S76). In addition, the application server 4 transmits the signed VC for user with the electronic signature to the user terminal 3 (step S77). The user terminal 3 that has received the signed VC for user with the electronic signature transfers the received signed VC for user with the electronic signature to the user wallet 3a (step S78). The user wallet 3a stores the transferred signed VC for user with the electronic signature in the user wallet 3a (step S79). The signed VC generation process ends by the processes described so far, and the entire signed VC issuance process also ends.

FIGS. 14 to 16 are diagrams illustrating a process flow of the signatory certification process. FIGS. 14 to 16 illustrate a case in which the user of the user terminal 3 uses the signed VC for user to ask the application server 4 for certifying that the signatory of a document is the user. Although the case of using the signed VC for user to ask for the certification will be described below, the same is true for a case of using the signed VC for document to ask for the certification. Although the application server 4 executes the signatory certification process in the following description, another computer may execute the signatory certification process.

First, with reference to FIG. 14, the user terminal 3 transmits a certification request including the signed VC for user with the electronic signature, the document file with the electronic signature, and the user DID to the application server 4 (step S80). The application server 4 that has received the certification request uses the public key (host public key) corresponding to the issuer DID included in the received signed VC for user, to decrypt the electronic signature of the signed VC for user (step S81), and derives a hash value of the signed VC for user (step S82). The application server 4 then compares them to verify the electronic signature of the signed VC for user (step S83) and determines whether or not the verification has succeeded (step S84). Specifically, the application server 4 can determine that the verification has succeeded, if the decrypted electronic signature is equal to the derived hash value, and determine that the verification has failed, otherwise. The application server 4 that has determined that the verification has failed returns information indicating the failure of certification to the user terminal 3 and ends the process. As a result of the verification, the application server 4 can confirm that the signed VC for user is not tampered.

The application server 4 that has determined in step S84 that the verification has succeeded then checks that the received user DID is equal to the signatory DID in the signed VC for user (step S85) and determines whether or not the check has succeeded (step S86). Specifically, the application server 4 can determine that the check has succeeded, if the received user DID is equal to the user DID in the signed VC for user, and determine that the check has failed, otherwise. The application server 4 that has determined that the check has failed returns information indicating the failure of verification to the user terminal 3 and ends the process. As a result of the check, the application server 4 can confirm that the user asking for the certification is the person specified by the signatory DID written in the signed VC.

The application server 4 that has determined in step S86 that the check has succeeded then extracts the document DID from the metadata of the received document file (step S88). The application server 4 checks that the extracted document DID is equal to the document DID in the signed VC for user (step S89) and determines whether the check has succeeded (step S90). Specifically, the application server 4 can determine that the check has succeeded if the extracted document DID is equal to the document DID in the signed VC for user and determine that the check has failed, otherwise. The application server 4 that has determined that the check has failed returns information indicating the failure of verification to the user terminal 3 and ends the process.

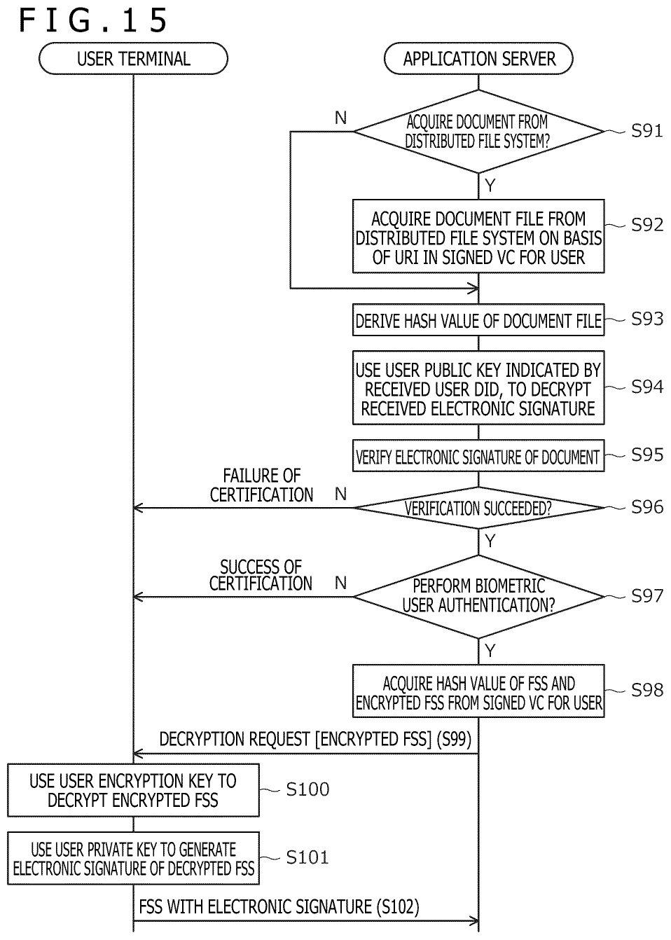

Described now with reference to FIG. 15, the application server 4 that has determined in step S90 that the check has succeeded then determines whether or not to acquire the document file from the distributed file system 6 (step S91). The determination result is set in advance by the administrator of the certificate issuance system 1. If the application server 4 determines to acquire the document file from the distributed file system 6, the application server 4 acquires the document file from the distributed file system 6 on the basis of the URI of the document file (=hash value of document file) stored in the signed VC for user (step S92). Note that, when the application server 4 determines in step S91 to acquire the document file from the distributed file system 6, the user may not necessarily transmit the document file with the electronic signature in step S80 of FIG. 14 and may transmit only the electronic signature of the document file.

Next, if the application server 4 acquires the document file from the distributed file system 6, the application server 4 derives a hash value of the document file acquired from the distributed file system 6, and if the application server 4 does not acquire the document file from the distributed file system 6, the application server 4 derives a hash value of the document file received from the user (step S93). In addition, the application server 4 uses the user public key indicated by the received user DID, to decrypt the electronic signature of the document file received from the user (step S94). The application server 4 then compares the derived hash value and the decrypted electronic signature to thereby verify the electronic signature of the document file (step S95) and determines whether or not the verification has succeeded (step S96). Specifically, the application server 4 can determine that the verification has succeeded, if the derived hash value is equal to the decrypted electronic signature, and determine that the verification has failed, otherwise. The application server 4 that has determined that the verification has failed returns information indicating the failure of certification to the user terminal 3 and ends the process. As a result of the verification, the application server 4 can specify, as the document file to be certified, the document file acquired from the distributed file system 6 or the document file received from the user.

The application server 4 that has determined in step S96 that the verification has succeeded then determines whether or not to perform user authentication using the biometric signature data (biometric user authentication) (step S97). The determination result is also set in advance by the administrator of the certificate issuance system 1. If the application server 4 determines not to perform the biometric user authentication, the application server 4 returns information indicating the success of certification to the user terminal 3 and ends the process.

The application server 4 that has determined in step S97 to perform the biometric user authentication first acquires the hash value of the FSS and the encrypted FSS from the signed VC for user (step S98). The application server 4 then transmits a decryption request of the encrypted FSS to the user terminal 3 (step S99).

The user terminal 3 that has received the decryption request of the encrypted FSS uses the user encryption key stored in the user wallet 3a, to decrypt the encrypted FSS (step S100). The user terminal 3 then uses the user private key stored in the user wallet 3a, to generate an electronic signature of the decrypted FSS (step S101) and returns the FSS with the electronic signature to the application server 4 (step S102).

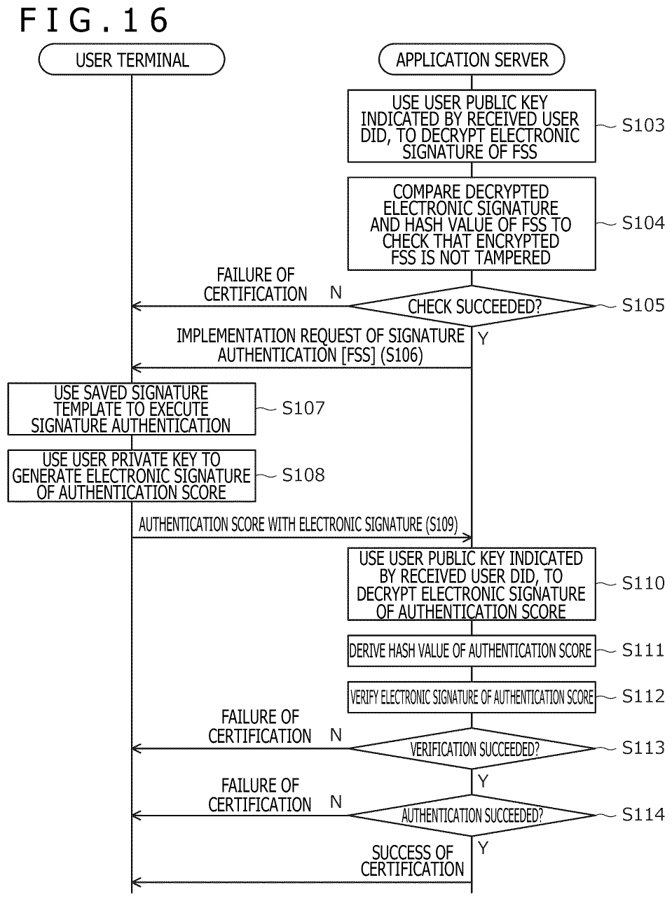

Described now with reference to FIG. 16, the application server 4 uses the user public key indicated by the user DID received in step S80 of FIG. 14, to decrypt the electronic signature of the FSS received in step S102 of FIG. 15 (step S103). The application server 4 then compares the decrypted electronic signature and the hash value of the FSS acquired in step S98 to check that the encrypted FSS in the signed VC for user is not tampered (step S104) and determines whether or not the check has succeeded (step S105). Specifically, the application server 4 can determine that the check has succeeded, if the decrypted electronic signature is equal to the hash value of the FSS acquired in step S98, and determine that the check has failed, otherwise. The application server 4 that has determined that the check has failed returns information indicating the failure of certification to the user terminal 3 and ends the process.

The application server 4 that has determined in step S105 that the check has succeeded transmits an implementation request of the signature authentication including the FSS received in step S102 to the user terminal 3 (step S106). The user terminal 3 that has received the request then uses the saved signature template to execute the signature authentication of the received FSS (step S107). Specifically, the user terminal 3 can cause the signature authentication server 5 to execute the signature authentication to receive the authentication score as an authentication result from the signature authentication server 5 as in steps S37 to S39 illustrated in FIG. 9.

The user terminal 3 that has acquired the authentication result uses the user private key stored in the user wallet 3a, to generate an electronic signature of the authentication score (step S108), and returns the authentication score with the electronic signature to the application server 4 (step S109). The application server 4 uses the user public key indicated by the user DID received in step S80, to decrypt the electronic signature of the received authentication score (step S110), and derives a hash value of the received authentication score (step S111). The application server 4 then compares them to verify the electronic signature of the authentication score (step S112) and determines whether or not the verification has succeeded (step S113). Specifically, the application server 4 can determine that the verification has succeeded, if the decrypted electronic signature is equal to the derived hash value, and determine that the verification has failed, otherwise. The application server 4 that has determined that the verification has failed returns information indicating the failure of certification to the user terminal 3 and ends the process.

Meanwhile, the application server 4 that has determined in step S113 that the verification has succeeded determines whether or not the signature authentication has succeeded, on the basis of the received authentication score (step S114). Specifically, the application server 4 can determine that the authentication has succeeded, if the authentication score is equal to or greater than a predetermined value, and determine that the authentication has failed, in other cases. Further, if the application server 4 determines that the authentication has succeeded, the application server 4 returns information indicating the success of certification to the user terminal 3, and if the application server 4 determines that the authentication has failed, the application server 4 returns information indicating the failure of certification to the user terminal 3. The user terminal 3 notifies the user of the information indicating the success of certification or the failure of certification returned in the process executed so far. As a result, the user can recognize whether or not the signatory of the document has been proved to be the user.

As described above, according to the certificate issuance system 1 of the present embodiment, the hash value of the document file and the user DID of the signatory are stored in the signed VC that can be verified by the electronic signature, and the document and the signatory can be associated with each other by the certificate. Therefore, the certificate that can prove the signatory of the document can be issued.

In addition, according to the certificate issuance system 1 of the present embodiment, it can be checked that the signed VC is not tampered, and it can be checked that the user asking for the certification is the person specified by the signatory DID written in the signed VC. Further, the document file to be certified can be specified. Therefore, the issued certificate can be used to certify the signatory of the document.

In addition, the encrypted FSS obtained with use of the private key of the signatory to encrypt the FSS representing the handwritten signature of the signatory and the hash value of the FSS are stored in the signed VC. Therefore, according to the certificate issuance system 1 of the present embodiment, the certification based on the biometric user authentication can also be performed in the certification based on the signed VC.

Although the preferred embodiment of the present disclosure has been described above, the present disclosure is not limited to the embodiment in any way, and it is obvious that the present disclosure can be carried out in various modes without departing from the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### DESCRIPTION OF REFERENCE SYMBOLS

1: Certificate issuance system
2: Network
3: User terminal
3a: User wallet
4: Application server
4a: Host wallet
5: Signature authentication server
6: Distributed file system
7: Blockchain network
10: Signature start button
11: Signature field
12: Selection button
13: Signature authentication completion display field
100: Computer
101: CPU
102: Storage apparatus
103: Input apparatus
104: Output apparatus
105: Communication apparatus
106: Bus
P: Pen

1. A method performed by one or more computers, the method comprising:
acquiring a user decentralized identifier for identifying a signatory who provides a handwritten signature to an electronic document;
calculating a hash value of a document file representing the electronic document provided with the handwritten signature by the signatory; and
generating a first certificate including the user decentralized identifier and the hash value of the document file.

2. The method according to claim 1, further comprising:
generating a first electronic signature of the first certificate by encrypting a hash value of the first certificate; and
generating a second certificate including the first electronic signature and the first certificate.

3. The method according to claim 2, wherein
the first electronic signature is generated by encrypting the hash value of the first certificate using a host private key that is a private key of an administrator who issues the first certificate.

4. The method according to claim 1, further comprising:
acquiring signature data representing the handwritten signature by the signatory; and
authenticating the signature data,
wherein the first certificate is generated after the authenticating of the signature data, and the first certificate further includes encrypted signature data that is generated by encrypting the signature data using an encryption key of the signatory and a hash value of the signature data.

5. The method according to claim 1, further comprising:
generating a second electronic signature by encrypting the hash value of the document file; and
generating a document file with the second electronic signature by adding the second electronic signature to the document file,
wherein the hash value of the document file is a hash value of the document file with the second electronic signature.

6. The method according to claim 5, wherein
the second electronic signature is generated by encrypting the hash value of the document file using a user private key that is a private key of the signatory.

7. The method according to claim 2, further comprising:
calculating a hash value of the first certificate included in the second certificate with the first electronic signature; and
encrypting the first electronic signature included in the second certificate with the first electronic signature to obtain a value and comparing the value and the hash value of the first certificate.

8. The method according to claim 3, further comprising:
calculating a hash value of the first certificate included in the second certificate with the first electronic signature; and
using a host public key corresponding to the host private key to decrypt the first electronic signature included in the second certificate with the first electronic signature to obtain a value and comparing the value and the hash value.

9. The method according to claim 5, further comprising:
calculating a hash value of the document file included in the document file with the second electronic signature; and
decrypting the second electronic signature included in the document file with the second electronic signature to obtain a value and comparing the value and the hash value of the document file.

10. The method according to claim 6, further comprising:
calculating a hash value of the document file included in the document file with the second electronic signature; and
using a user public key corresponding to the user private key to decrypt the second electronic signature included in the document file with the second electronic signature and obtain a value and comparing the value and the hash value of the document file.

11. The method according to claim 4, further comprising:
generating the signature data by decrypting the encrypted signature data included in the first certificate using the encryption key of the signatory;
generating a third electronic signature by encrypting a hash value of the signature data using a user private key that is a private key of the signatory;
generating signature data with the third electronic signature by adding the third electronic signature to the signature data; and
decrypting the third electronic signature included in the first certificate with the third electronic signature to obtain a value and comparing the value and the hash value of the signature data included in the first certificate.

12. The method according to claim 11, further comprising:
using a user public key corresponding to the user private key to decrypt the third electronic signature included in the document file with the third electronic signature to obtain a value and comparing the value and the hash value of the signature data included in the first certificate.

13. A computer comprising:
a processor, wherein
the processor is configured to
acquire a user decentralized identifier for identifying a signatory who provides a handwritten signature to an electronic document,
calculate a hash value of a document file representing the electronic document provided with the handwritten signature by the signatory, and
generate a first certificate including the user decentralized identifier and the hash value of the document file.

14. The computer according to claim 13, wherein
the processor is further configured to
generate a first electronic signature of the first certificate by encrypting a hash value of the first certificate,
generate a second certificate including the first electronic signature and the first certificate,
calculate a hash value of the first certificate included in the second certificate with the first electronic signature, and
decrypt the first electronic signature included in the second certificate with the first electronic signature to obtain a value and compare the value and the hash value of the first certificate.

15. A non-transitory computer-readable medium storing a program that, when executed by a computer, causes the computer to:
acquire a user decentralized identifier for identifying a signatory who provides a handwritten signature to an electronic document;
calculate a hash value of a document file representing the electronic document provided with the handwritten signature by the signatory; and
generate a first certificate including the user decentralized identifier and the hash value of the document file.

16. The computer-readable medium according to claim 15, wherein the program, when executed by the computer, causes the computer to:
generate a first electronic signature of the first certificate by encrypting a hash value of the first certificate;
generate a second certificate including the first electronic signature and the first certificate;
calculate a hash value of the first certificate included in the second certificate with the first electronic signature; and
decrypt the first electronic signature included in the second certificate with the first electronic signature to obtain a value and comparing the value and the hash value of the first certificate.
